(19) United States
(12) Patent Application Publication
(10) Pub. No.: US 2025/0164380 A1
(43) Pub. Date: May 22, 2025

(54) Systems and Methods for Identifying and Recovering Rare Biological Cells from a Sample

(71) Applicant: The Trustees of Columbia University in the City of new York, New york, NY (US)

(72) Inventors: Samuel Z. WILLIAMS, New York City, NY (US); Hemant Suryawanshi, Guttenberg, NJ (US)

(73) Assignee: The Trustees of Columbia University in the City of New York, New York, NY (US)

(21) Appl. No.: 19/036,372

(22) Filed: Jan. 24, 2025

Related U.S. Application Data
(63) Continuation-in-part of application No. PCT/US2023/028843, filed on Jul. 27, 2023.
(60) Provisional application No. 63/392,628, filed on Jul. 27, 2022.

(51) Int. Cl. G01N 15/14; B01L 3/00; G01N 15/10; G01N 15/1434; G01N 15/149; G06V 10/82; G06V 20/69

(52) U.S. Cl. CPC G01N 15/147; B01L 3/502761; B01L 3/502776; G01N 15/149; G06V 10/82; G06V 20/698; B01L 2300/0663; B01L 2300/0864; B01L 2400/0487; B01L 2400/0633; G01N 2015/1006; G01N 2015/144

(57) ABSTRACT

Biological cells can be identified and recovered from a sample by pumping the sample through a flow channel so that the sample flows through the flow channel with a non-turbulent flow (e.g., a laminar flow). A plurality of images of the sample are captured as the sample passes through the flow channel. These images are analyzed to determine which portions of the sample include a target biological cell. Portions of the sample that were determined to include a target biological cell are routed into at least one first container, and portions of the sample that were not determined to include a target biological cell are routed to at least one second destination (e.g., one or more second containers).

### CROSS REFERENCE TO RELATED APPLICATIONS

This Application is a continuation-in-part of International Application No. PCT/US2023/028843, filed Jul. 27, 2023, which claims the benefit of U.S. Provisional Application 63/392,628, filed Jul. 27, 2022, each of which is incorporated herein by reference in its entirety.

### BACKGROUND

A normal sperm count is between 15 million to more than 200 million sperm per ml of semen. Below those levels, as long as the semen contains a significant amount of sperm (e.g., around 1 million sperm per ml), many techniques exist for extracting sperm for in vitro fertilization. But some men have extremely low sperm counts, e.g., less than 10 sperm cells per ml. Identification and recovery of sperm cells in semen samples from these men and in testicular biopsy samples has heretofore been challenging because the semen sample includes very few sperm cells but a high number of other cells and debris. Identification and recovery of sperm cells for use in fertilization is also difficult because, in order to use the sperm cells in subsequent procedures, the identification and recovery processes must not damage the sperm cells. The aforementioned challenges also apply to identifying and recovering other types of rare biological cells such as cancer cells, fetal cells, and placenta cells.

Existing cell identification and sorting technologies do not provide any good solutions for the problems described above. For example, a fluorescence-activated cell sorting (FACS) sorting approach is impractical for sorting sperm cells and other rare cells due to lack of specific monoclonal antibodies against the cells. Further, the high-pressure system used in a FACS machine could potentially damage the cells, and would therefore be detrimental to the use of the cells for any sensitive biological applications. In addition, FACS requires at least 10,000 cells. Other sorting approaches, such as magnetic-activated cell sorting (MACS) based separation, are unsuitable for use with sperm cells that are present in very low numbers or other rare cells because these approaches lack sensitivity and work only at high cell concentration ranges.

### SUMMARY OF THE INVENTION

One aspect of this application is directed to a first apparatus for identifying and recovering biological cells from a sample. The first apparatus comprises a fluid flow conduit, a pump, a camera, a stage, and a processor. The fluid-flow conduit has an inlet and an outlet, with a flow channel disposed between the inlet and the outlet. The inlet and the flow channel are configured so that the sample flows through the flow channel with a non-turbulent flow. The pump is configured to pump the sample into the inlet so that the sample flows through the flow channel with a non-turbulent flow and exits the outlet, and so that respective portions of the sample are dispensed from the outlet at respective times. The camera is positioned to capture a plurality of images of the sample as the sample passes through the flow channel. The stage is configured to move a plate that includes a plurality of microwells to respective positions at which respective portions of the sample flow out of the outlet and into respective ones of the plurality of microwells. And the processor is configured to analyze the plurality of images to detect which of the plurality of images include a target biological cell, and keep track of which microwells have been filled with a target biological cell.

In some embodiments of the first apparatus, the inlet and the flow channel are configured so that the sample flows through the flow channel with a laminar flow, and the pump is configured to pump the sample into the inlet so that the sample flows through the flow channel with a laminar flow.

In some embodiments of the first apparatus, the flow channel has a height between 10 and 50 μm, and a width between 100 and 400 μm. In some embodiments of the first apparatus, the flow channel has a height between 15 and 25 μm. In some embodiments of the first apparatus, a flow rate of the sample is between 800 and 2000 μL/hr. In some embodiments of the first apparatus, a width of the inlet is greater than a width of the flow channel, and the inlet includes a conical transition to the flow channel.

In some embodiments of the first apparatus, the processor keeps track of which microwells have been filled with the target biological cell by recording data corresponding to the plurality of images.

In some embodiments of the first apparatus, the camera is positioned and focused to capture images of a vertically central portion of the flow channel having a height between 2 and 8 μm. In some embodiments of the first apparatus, the camera is positioned and focused to capture images of a vertically central portion of the flow channel having a height between 4 and 6 μm.

In some embodiments of the first apparatus, the processor is further configured to analyze the plurality of images using an object detection model. In some embodiments of the first apparatus, the processor is further configured to analyze the plurality of images using a YOLO object detection model. In some embodiments of the first apparatus, the target biological cell is any one of a sperm cell, a cancer cell, a fetal cell, and a placenta cell. In some embodiments of the first apparatus, the camera is further configured to capture the plurality of images at a rate of at least 100 frames per second.

Some embodiments of the first apparatus further comprise a controller configured to issue commands to the stage to cause the stage to move the plate to the respective positions.

Another aspect of this application is directed to a first method of identifying and recovering biological cells from a sample. The first method comprises pumping a sample through a flow channel so that the sample flows through the flow channel with a non-turbulent flow; capturing a plurality of images of the sample as the sample passes through the flow channel; analyzing the plurality of images to detect which of the plurality of images include a target biological cell; moving a plate including a plurality of microwells to respective positions at which respective portions of the sample flow out of an outlet of the flow channel and into respective ones of the plurality of microwells; and keeping track of which microwells have been filled with a target biological cell.

In some instances of the first method, the sample flows through the flow channel with a laminar flow. In some instances of the first method, the sample flows through the flow channel at a flow rate between 800 and 2000 μL/hr. In some instances of the first method, the keeping track of which microwells have been filled with the target biological cell includes recording data corresponding to the plurality of images.

In some instances of the first method, the capturing of the plurality of images includes capturing the plurality of images using a camera focused on a vertically central portion of the flow channel having a height between 2 and 8 μm. In some instances of the first method, the capturing of the plurality of images includes capturing the plurality of images using a camera focused on a vertically central portion of the flow channel having a height between 4 and 6 μm.

In some instances of the first method, the analyzing of the plurality of images is implemented using an object detection model. In some instances of the first method, the analyzing of the plurality of images is implemented using a YOLO object detection model. In some instances of the first method, the target biological cell detected in the image is any one of a sperm cell, a cancer cell, a fetal cell, and a placenta cell. In some instances of the first method, the capturing of the plurality of images includes capturing the plurality of images at a rate of at least 100 frames per second.

In some instances of the first method, portions of the sample that correspond to images that include a target biological cell are deposited into one well and portions of the sample that correspond to images that do not include a target biological cell are deposited into a different well.

Another aspect of this application is directed to a second method of identifying and recovering biological cells from a sample. The second method comprises pumping the sample through a flow channel so that the sample flows through the flow channel with a non-turbulent flow; capturing a plurality of images of the sample as the sample passes through the flow channel; and analyzing the plurality of images to determine which portions of the sample include a target biological cell. Portions of the sample that were determined to include a target biological cell are routed into at least one first container, and portions of the sample that were not determined to include a target biological cell are routed to at least one second destination.

In some instances of the second method, the sample flows through the flow channel with a laminar flow. In some instances of the second method, the sample flows through the flow channel at a flow rate between 800 and 2000 μL/hr. In some instances of the second method, the capturing of the plurality of images includes capturing the plurality of images using a camera focused on a vertically central portion of the flow channel having a height between 2 and 8 μm. In some instances of the second method, the capturing of the plurality of images includes capturing the plurality of images using a camera focused on a vertically central portion of the flow channel having a height between 4 and 6 μm.

In some instances of the second method, the analyzing of the plurality of images is implemented using an object detection model. In some instances of the second method, the analyzing of the plurality of images is implemented using a YOLO object detection model. In some instances of the second method, the target biological cell is any one of a sperm cell, a cancer cell, a fetal cell, and a placenta cell. In some instances of the second method, the capturing of the plurality of images includes capturing the plurality of images at a rate of at least 100 frames per second.

In some instances of the second method, portions of the sample that were determined to include a target biological cell are deposited into a single first container, and portions of the sample that were not determined to include a target biological cell are deposited into a single second container.

Another aspect of this application is directed to a second apparatus for identifying and recovering biological cells from a sample. The second apparatus comprises a flow channel, a pump, a camera, a processor, and routing means. The pump is configured to pump the sample through the flow channel, and the flow channel and the pump are configured so that the sample flows through the flow channel with a non-turbulent flow. The camera is configured to capture a plurality of images of the sample as the sample passes through the flow channel. The processor is configured to analyze the plurality of images to determine which portions of the sample include a target biological cell. And the routing means is configured for (a) routing portions of the sample that were determined to include a target biological cell into at least one first container, and (b) routing portions of the sample that were not determined to include a target biological cell to at least one second destination.

In some embodiments of the second apparatus, the flow channel and the pump are configured so that the sample flows through the flow channel with a laminar flow. In some embodiments of the second apparatus, the flow channel and the pump are configured so that the sample flows through the flow channel at a flow rate between 800 and 2000 μL/hr. In some embodiments of the second apparatus, the camera is focused on a vertically central portion of the flow channel having a height between 2 and 8 μm. In some embodiments of the second apparatus, the camera is focused on a vertically central portion of the flow channel having a height between 4 and 6 μm.

In some embodiments of the second apparatus, the processor analyzes the plurality of images using an object detection model. In some embodiments of the second apparatus, the processor analyzes the plurality of images using a YOLO object detection model. In some embodiments of the second apparatus, the target biological cell is any one of a sperm cell, a cancer cell, a fetal cell, and a placenta cell. In some embodiments of the second apparatus, the camera captures the plurality of images at a rate of at least 100 frames per second.

In some embodiments of the second apparatus, the routing means is configured so that portions of the sample that were determined to include a target biological cell are deposited into a single first container, and portions of the sample that were not determined to include a target biological cell are deposited into a single second container.

Another aspect of this application is directed to a third apparatus for identifying and recovering biological cells from a sample. The third apparatus comprises a fluid flow conduit, a pump, a camera, at least one valve, and a processor. The fluid-flow conduit has an inlet and an outlet, with a flow channel disposed between the inlet and the outlet. The inlet and the flow channel are configured so that the sample flows through the flow channel with a non-turbulent flow. The pump is configured to pump the sample into the inlet so that the sample flows through the flow channel with a non-turbulent flow and exits the outlet, and so that respective portions of the sample exit the outlet at respective times. The camera is positioned to capture a plurality of images of the sample as the sample passes through the flow channel. The at least one valve is configured to route a plurality of first portions of the sample that exit the outlet into at least one first container and to route a plurality of second portions of the sample that exit the outlet to at least one second destination. The processor is configured to analyze the plurality of images to determine which portions of the sample include a target biological cell. And the processor is also configured to, based on the analyzing, control the at least one valve so that (a) portions of the sample that exit the outlet and were determined to include a target biological cell are routed into the at least one first container and (b) portions of the sample that exit the outlet and were not determined to include a target biological cell are routed to the at least one second destination.

In some embodiments of the third apparatus, the inlet and the flow channel are configured so that the sample flows through the flow channel with a laminar flow, and the pump is configured to pump the sample into the inlet so that the sample flows through the flow channel with a laminar flow. In some embodiments of the third apparatus, the flow channel has a height between 10 and 50 μm, and a width between 100 and 400 μm. In some embodiments of the third apparatus, the flow channel has a height between 15 and 25 μm. In some embodiments of the third apparatus, a flow rate of the sample is between 800 and 2000 μL/hr.

In some embodiments of the third apparatus, a width of the inlet is greater than a width of the flow channel, and the inlet includes a conical transition to the flow channel. In some embodiments of the third apparatus, the camera is positioned and focused to capture images of a vertically central portion of the flow channel having a height between 2 and 8 μm. In some embodiments of the third apparatus, the camera is positioned and focused to capture images of a vertically central portion of the flow channel having a height between 4 and 6 μm.

In some embodiments of the third apparatus, the processor is further configured to analyze the plurality of images using an object detection model. In some embodiments of the third apparatus, the processor is further configured to analyze the plurality of images using a YOLO object detection model.

In some embodiments of the third apparatus, the target biological cell is any one of a sperm cell, a cancer cell, a fetal cell, and a placenta cell. In some embodiments of the third apparatus, the camera is further configured to capture the plurality of images at a rate of at least 100 frames per second.

In some embodiments of the third apparatus, the valve is configured to route a plurality of first portions of the sample that exit the outlet into a single first container and to route a plurality of second portions of the sample that exit the outlet to a single second destination. Optionally, in these embodiments, the single second destination can be a single second container.

In some embodiments of the third apparatus, the at least one valve comprises a plurality of PDMS quake valves. In some embodiments of the third apparatus, the at least one valve comprises a plurality of lateral deflection valves, and each of the lateral deflection valves is implemented using a single PDMS layer.

In some embodiments of the third apparatus, the at least one valve comprises a fluid-flow circuit having a main flow inlet, a first outlet, a second outlet, and a control flow inlet, and the fluid-flow circuit is configured so that (a) applying a control flow to the control flow inlet at a first flow rate causes fluid from the main flow inlet to flow out of the first outlet and (b) applying a control flow to the control flow inlet at a second flow rate causes fluid from the main flow inlet to flow out of the second outlet. Optionally, in these embodiments, the first flow rate is larger than the flow rate at the main flow inlet, and the second flow rate is smaller than the flow rate at the main flow inlet.

Other features and aspects will be apparent from the following detailed description, the drawings, and the claims.

### BRIEF DESCRIPTION OF THE DRAWINGS

FIG. 1 is a diagram of a system for identifying and recovering biological cells that are present in a sample.

FIG. 2 is a plan view of a fluid-flow conduit of the system of FIG. 1.

FIG. 3 is a cross-sectional view taken along line A-A of FIG. 2.

FIG. 4 is a graph illustrating accuracy of the system of FIG. 1 in identifying sperm in a human semen sample using a YOLOv4 object detection model, according to an experimental embodiment.

FIG. 5 is an image processed by the system of FIG. 1 that includes sperm identified using the YOLOv4 object detection model, according to an experimental embodiment.

FIGS. 6-9 depict successive images of a test sample that were captured while a single sperm cell moved through a flow channel in an experiment.

FIG. 10 depicts another system for identifying and recovering target cells that are present in a sample.

FIGS. 11-13 depict three alternative approaches for routing different portions of the sample to different destinations in the FIG. 10 embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF THE PREFERRED EMBODIMENTS

In view of the shortcomings of the prior art identified above, it would be desirable to provide a system and method that are capable of accurately and efficiently identifying and capturing sperm cells from samples that contain an extremely low number of sperm cells, without damaging those sperm cells, so that they can subsequently be used (e.g., for in vitro fertilization).

Ordinarily, if a semen sample that contains very few sperm cells (e.g., less than 100 sperm cells per ml) is pumped through a channel that is large enough for semen to flow through without clogging, conventional techniques will not be able to identify and capture the sperm cells. Two factors contribute to this difficulty: first, other cells and debris in the semen can outnumber the target sperm cells by over 100,000:1. And second, the cross-section of the channel is so large that it is impossible to keep the entire cross-section of the channel in focus to identify the extremely rare target sperm cells for subsequent capture.

The embodiments described herein overcome this problem by, inter alia, making sure that non-turbulent flow (e.g., laminar flow) is maintained through the channel. When laminar flow is a maintained, the flow is slower near the walls of the channel and faster near the center of the channel. As a result, the majority of the sample ends up flowing through the center of the channel. Because the majority of the sample flows through the center of the channel, it becomes possible for a microscope to maintain focus on the entire cross-section of the center of the channel through which the majority of the sample flows. And when the entire cross-section of flow can be kept in focus, the system can spot the rare sperm cells in images captured using the microscope and a camera as they traverse the channel.

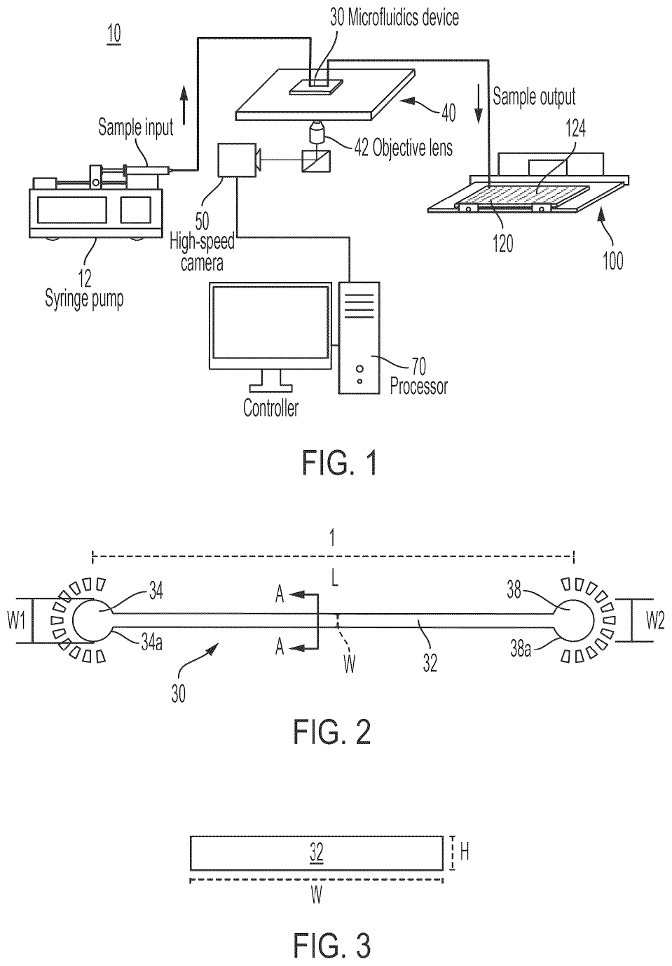

FIG. 1 illustrates an embodiment of a system 10 for identifying and recovering target cells present in a sample. The system 10 will be described in the context of identifying and recovering sperm cells present in a semen sample, but can also be used in a variety of other contexts.

The FIG. 1 embodiment includes a syringe pump 12, a fluid-flow conduit 30 including a flow channel 32, a camera 50, a processor 70, and a stage 100 supporting a microplate (or plate) 120. As will be described later in more detail, the syringe pump 12 pumps a semen sample containing sperm cells through the fluid-flow conduit 30, the camera 50 captures images of the semen sample and the sperm cells therein as the semen sample flows through a fluid channel 32 of the fluid-flow conduit 30, and the processor 70 detects the sperm cells in the semen sample. The microplate 120 is positioned using the stage 100 to collect respective portions of the semen sample as the semen sample flows out of the fluid-flow conduit 30.

To ensure that that the camera 50 is able to capture sharply focused images and the sample collection station properly captures portions of the semen sample, it is important for the semen sample to have a consistent, precise flow rate through the flow channel 32 of the fluid-flow conduit 30. A semen sample will typically have a volume of 1 to 3 ml. In the illustrated embodiment, a syringe pump 12 is configured to pump the semen sample through the flow channel 32 of the fluid-flow conduit 30. But in alternative embodiments, different types of pumps may be used. In some embodiments, the pump 12 pumps the semen sample through the flow channel 32 at a flow rate of 800 to 2000 μL/hr (e.g., 1000 μL/hr). The inventors have experimentally determined that flow rates in these ranges can advantageously process human semen samples quickly without causing image blurring. But in alternative embodiments, flow rates outside these ranges can also be used.

Referring to FIGS. 1-3, the fluid-flow conduit 30 includes the flow channel 32, an inlet 34 disposed at a first end of the flow channel 32, and configured to receive the semen sample from the pump 12 and introduce the semen sample to the fluid flow channel 32, and an outlet 38 disposed at a second end of the flow channel 32 and configured dispense the semen sample to the microplate 120. The camera 50 is configured to capture images of the semen sample and the sperm cells therein as the semen sample flows through the flow channel 32. Thus, the fluid-flow conduit 30 or at least the flow channel 32 should be made of a transparent material.

If the sperm cells in the semen sample are stacked or widely distributed through the cross-section of the flow channel 32 in the direction of the viewing axis of the camera 50, the camera 50 will fail to image the majority of the sperm cells as they flow through the flow channel 32 and/or will capture unfocused images of the majority of the sperm cells. That is, such stacking or distribution of sperm cells will cause the majority of the sperm cells to be disposed outside of the depth of field (DOF) of the camera 50. Further, if the semen sample forms clumps of semen that do not flow consistently in the flow channel 32, the camera 50 cannot accurately image the sperm cells throughout the length of the flow channel 32, thereby preventing the system 10 from tracking and recovering at least some of the sperm cells.

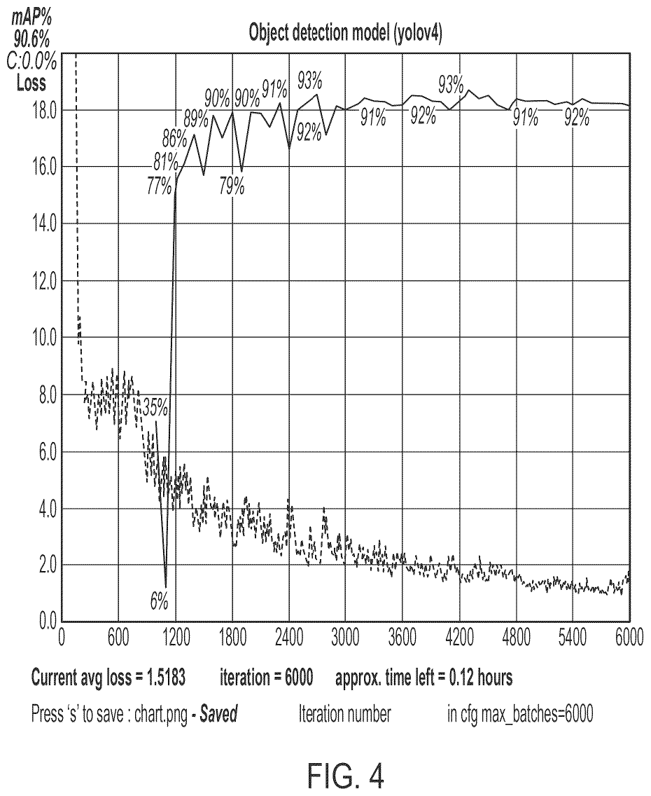

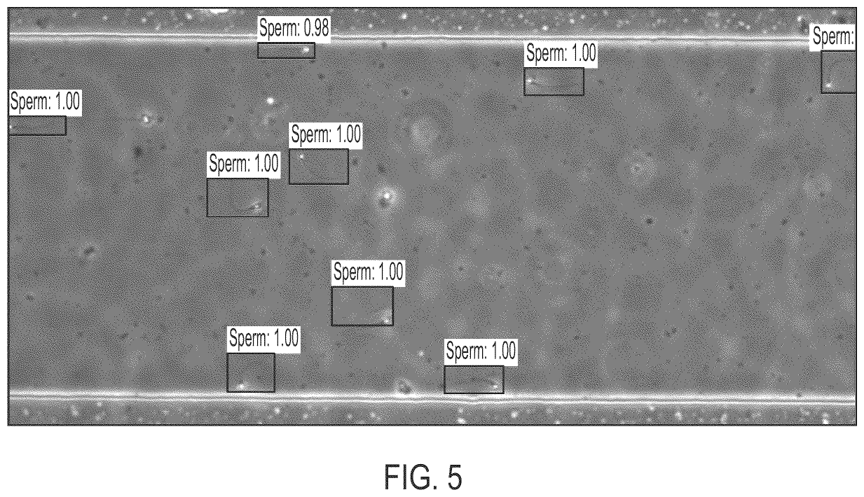

For example, referring to FIGS. 2 and 3, if a height H (in the direction of the viewing axis of the camera 50) of the flow channel 32 is too large, the aforementioned problem of stacking and wide distribution of the sperm cells will occur along the height H. If the height H is too small, the aforementioned problem of clumping of the semen sample will occur. Additionally, stacking of sperm cells along the height H or clumping of the semen may occur if a width W of the flow channel 32 is not sized in appropriate proportion to the height H.

Further, unless care is taken to ensure that the flow of the sample through the flow channel 32 is non-turbulent, turbulence in the sample will cause blurring in images captured by the camera 50 due to erratic motion of the semen sample, and will prevent the flow of the semen sample from being concentrated at a vertically central portion of the flow channel 32, thereby causing the problem of stacking and wide distribution of the sperm cells along the height H.

To avoid the problems described above and enable the camera 50 to capture well-focused images of all of the sperm cells in the semen sample, the flow channel 32, the inlet 34, and the outlet 38 are shaped and dimensioned to provide a non-turbulent flow of the semen sample from the inlet 34, through the flow channel 32 and to the outlet 38, and to maintain the flow of the semen sample at a vertically central portion of the flow channel 32. For example, the flow channel 32, the inlet 34, and the outlet 38 can be shaped and dimensioned to provide a laminar flow of the semen sample throughout the entire flow channel 32.

FIGS. 2 and 3 depict a suitable set of dimensions for an inlet 34, flow channel 32 and an outlet 38 that results in a non-turbulent, laminar, flow through the flow channel 32. In this embodiment, the flow channel 32 has a substantially rectangular cross-sectional shape, the inlet 34 has a shape including a conical transition 34a to the flow channel 32, and the outlet 38 has a shape including a conical transition 38a from the flow channel 32. The inlet 34 and the outlet 38 have respective widths W1 and W2 that are greater than a width W of the flow channel 32. One example of suitable dimensions for the flow channel 32 that facilitates non-turbulent flow is a height H of 40 μm, a width of 300 μm, and a length of 1 cm. But in alternative embodiments, the height of the flow channel 32 could range from 10 to 50 μm, and the width of the flow channel 32 could range from 100 to 400 μm. The length of the flow channel 32 is less critical, and in alternative embodiments the length could range from 0.5 to 5 cm.

These dimensions for the flow channel 32, the inlet 34, and the outlet 38 were found to provide excellent sample flow characteristics when the system 10 was used to identify sperm cells in human semen samples. That is, the foregoing configurations of the flow channel 32, the inlet 34, and the outlet 38 exhibited laminar flow of the semen samples through the flow channel 32 without clumping, and the flow of the semen samples was located within a vertically central portion of the flow channel 32.

Notably, with the foregoing configurations of the fluid-flow conduit 30, most of the sample will flow with a laminar flow through the central-most 8 μm portion of the flow channel 32. In some embodiments, most of the sample will flow through the central-most 6 μm portion, the central-most 5 μm portion, the central-most 4 μm portion, the central-most 3 μm portion, or even the central-most 2 μm portion of the flow channel 32. Thus, the flow of the sample is confined within a vertically central region of the flow channel 32, such that the target cells are not vertically stacked in the flow channel 32 and the flow of the sample falls within a DOF of the camera 50, which can be small (e.g., 2, 3, 4, 5, 6, or 8 μm).

Additionally, the disclosed values for the width W of the flow channel 32 promote the desired flow characteristics and provide an optimal region of interest (ROI) in which images of the sample are captured by the camera 50. Further, the disclosed values for the length L promotes the desired sample flow characteristics and enables the camera 50 to acquire an adequate number of images of sperm cells as the sperm cells travel through the flow channel 32 as described below. Note that in alternative embodiments, the height and width of the flow channel 32 could be outside the numeric ranges indicated above.

Maintaining non-turbulent (e.g., laminar) flow is important because turbulent flow would cause the sperm cells and debris to be distributed across the full z-axis, which would make it difficult if not impossible to keep the relevant cells in focus and to keep track of the sperm cells as they traverse the flow channel. For if the sperm cells were distributed across the full z-axis, (a) only a small fraction of sperm would be visible in any given image and (b) those sperm would likely NOT remain seen across multiple images and thus would be much more difficult to positively identify. In contrast, when non-turbulent (e.g., laminar) flow is maintained, the majority of the sample (including the sperm cells) will flow through a vertically central region of the flow channel 32 that is short enough in height (e.g., a few um) so that the majority of the sample (including the sperm cells) will remain in focus as they traverse the flow channel 32. This is important because it allows the sperm cells to be visualized by the camera 50 as they pass under the microscope. Notably, in experiments where 30 sperm cells were inserted into a sample and pumped through a flow channel 32 with a height H of 40 μm, a width of 300 μm, and a length of 1 cm, 8-12 sperm cells were consistently detected, and sometimes more. This means that at least those sperm cells flowed through a portion of the flow channel 32 that was short enough such they were sufficiently in focus to be visualized.

The fluid-flow conduit 30 can be included in a microfluidics device and can be positioned on a microscope 40 such that the fluid channel 32 is optically aligned with an objective lens 42 of the microscope 40. The microscope 40 can be a phase contrast microscope, but is not limited thereto.

The camera 50 includes one or more lenses configured to be aligned with the objective lens 42 to capture images of the semen sample as the semen sample flows through the flow channel 32. Since the flow of a semen sample through the flow channel 32 is confined to the vertically central portion of the flow channel 32, as described above, the camera 50 can be precisely focused on the entire vertically central portion of the flow channel 32 and can therefore capture clear, properly focused images of most of the sperm cells in the semen sample. For example, the camera 50 can be focused on a vertically central portion of the flow channel 32 having a height in a range of 2 to 8 μm.

The camera 50 is a high-speed camera. The resolution, shutter speed, frame rate, trigger time, and other parameters of the camera 50 should be such that the camera acquires multiple images of sperm cells in the semen sample as the sperm cells pass through the flow channel 32. The parameters of the camera 50 are optimized to make sure captured images are not blurry and the same sperm cell is captured in multiple images, at various locations along the flow channel 32. The camera 50 can be configured to capture images at a frame rate of at least 100 frames per second. For example, the camera 50 can capture images at a frame rate of 500 frames per second. The camera 50 can capture images of the same sperm cell at least 5 times as the sperm cell passes through the flow channel 32, and can capture more than two million images of the sperm sample. Capturing multiple images of the same sperm cell as the sperm cell travels along the flow channel 32 can advantageously improve the system's confidence that what appears to be a sperm cell in one image is indeed a sperm cell.

Operation of the camera 50 can be controlled by the processor 70, or by a dedicated controller of the camera 50. Images captured by the camera 50 can be stored in a memory, which can include one or more high-capacity solid state drives (SSDs). The processor 70 analyzes the images captured by the camera 50 to identify target sperm cells in the semen sample and keeps track of which images contain the target sperm cells (e.g., in a memory, not shown). The processor 70 can include one or more GPU-based computational systems that apply a pre-trained neural network to the images captured by the camera 50 to identify the target sperm cells in the images.

In a semen sample from a person who has an extremely low sperm count (e.g., less than 10 sperm cells per ml), sperm cells are present in very small numbers and are therefore rare cells. Accurate identification of the sperm cells is challenging because other cells and debris are present in large proportion in the sample, relative to the sperm cells. For example, semen samples may also include the following components that are visible through microscopy: epithelial cells from the urogenital tract; myeloid cells; leukocytes (white blood cells); red blood cells; immature germ cells; and fragments of cells. Due to the large proportion of other cells and debris in the semen sample, the techniques that are used to identify the sperm cells must have extremely low error rates in order to provide meaningful identification results. That is, due to the large number of other cells and debris in the semen sample, even a modest error (false positive) rate in a sperm cell identification technique will produce a very large number of false positive sperm cell identifications.

Existing neural-network based image classification techniques have proved to be insufficiently accurate for identifying rare sperm cells. But when the processor 70 was programmed to implement a trained object detection model to identify sperm cells in a semen sample, successful results were obtained. More specifically, successful results were obtained when the processor 70 was programmed to implement a trained “you only look once” (YOLO) object detection model. For example, the object detection model can be a YOLOv4 object detection model. The trained object detection model is trained based on millions of training images containing sperm cells being input to an object detection model in a training phase.

The processor 70 inputs each of the captured images of the semen sample flowing through the flow channel 32 to the object detection model, and identifies sperm cells in the captured images based on outputs generated by the object detection model. The processor 70 records data regarding each of the images input to the object detection model. The recorded data can include, for example, time information indicating a time at which the image was captured, position information indicating a position of the sperm cell in the flow channel 32 when the image was captured, target cell information indicating whether the image contains a sperm cell, and an indication of which images correspond to which microwells.

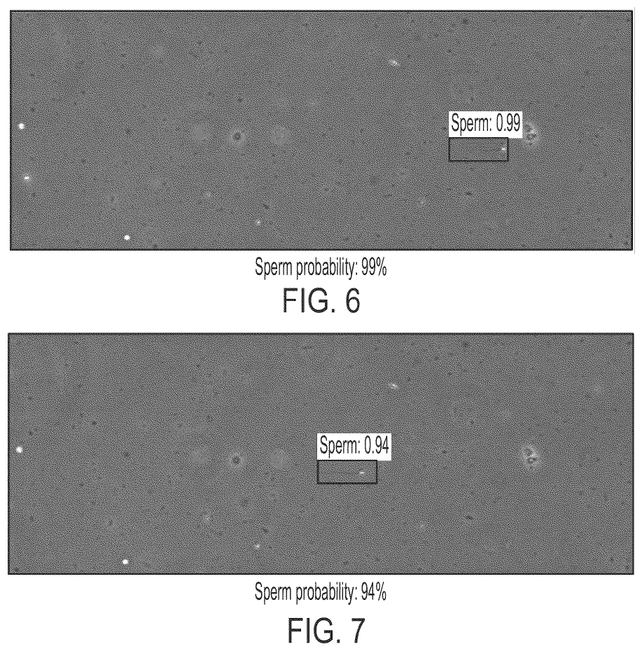

FIG. 4 is a graph illustrating accuracy of the system 10 in identifying sperm cells in a human semen sample using a trained YOLOv4 object detection model, according to an experimental embodiment. As illustrated in FIG. 4, the system 10 exhibited a high mean average precision (mAP) and low loss.

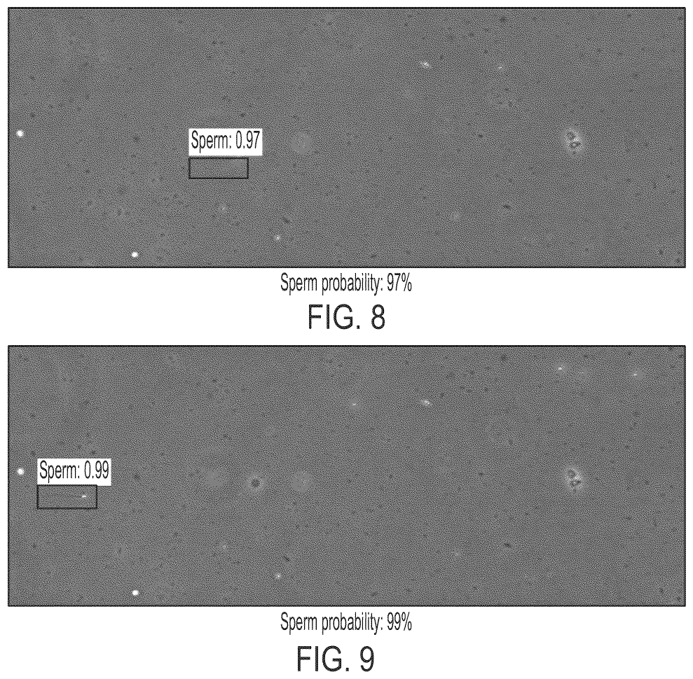

FIG. 5 is an image processed by the system 10 that includes sperm cells identified using the YOLOv4 object detection model, according to an experimental embodiment. Sperm cells were accurately identified with high probability scores.

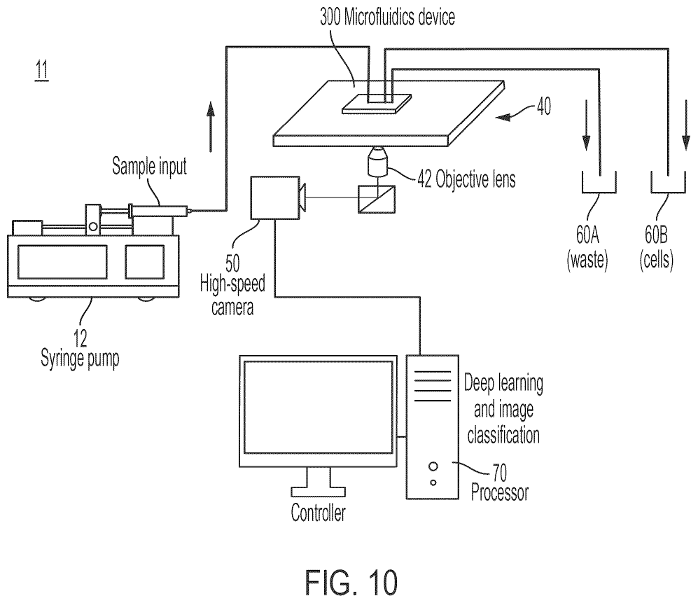

FIGS. 6-9 depict successive images of a test sample that were captured while a single sperm cell moved through a flow channel 32 from right to left in an experiment. Notably, the same sperm cell appears at different locations in each of the successive images, which indicates that the sperm was moving from right to left (which was consistent with the direction of flow of the sample through the flow channel 32). Because each sperm cell appears in multiple images as the sperm cell moves through the flow channel 32, the probability of identifying any given sperm cell increases dramatically, and the probability of a false positive identification decreases dramatically. Assume, for example, that a given sperm cell was identified in four successive images with respective probabilities of 99%, 94%, 97%, and 99%. This means that the respective probability of a false positive in those images would be 1%, 6%, 3%, and 1%. While the risk of a false positive may not be sufficiently low in any single given image, combining the information from multiple images (e.g., 2, 3, 4, 5, 6, or >6 images) reduces the overall probability of a false positive to the point where the false positive rate becomes negligible.

Referring back to FIG. 1, the microplate 120 is disposed on or supported by the stage 100, and arranged to collect portions of the sperm sample as they exit the outlet 38 of the fluid-flow conduit 30. More specifically, the microplate 120 includes a plurality of microwells 124 configured to contain respective portions of the semen sample. For example, the microplate 120 can include between 50 and 500 microwells (e.g., 96 or 384 microwells).

In some embodiments, the microwells 124 are arranged in a two-dimensional array and the stage 100 can move in the two dimensions (e.g., X and Y) of the array, and thereby move the microplate 120 in the two dimensions so that respective microwells receive respective portions of the semen sample. In less preferred embodiments, the microwells can be arranged in a one-dimensional array, in which case the stage only has to move in a single dimension to receive the respective portions of the semen sample. In other embodiments, the stage 100 can move in three dimensions (e.g., X, Y, and Z), and thereby move the microplate 120 in three dimensions to receive portions of the semen sample.

The stage 100 is configured to move precisely in one or more dimensions, to thereby move the microplate 120 in the one or more dimensions to respective positions where the respective portions of the semen sample flow out of the outlet 38 and into the respective ones of the plurality of microwells 124. Each microwell 124 can receive a prescribed volume of the semen sample, and the entire semen sample can be collected by the microwells 124.

The above-described movements of the stage 100 can be controlled by the processor 70 or by an independent controller (not shown). More specifically, the processor 70 or the controller can issue commands to the stage 100 to cause the stage 100 to move in one or more directions as described above.

The processor 70 keeps track of which microwells contain sperm cells. More specifically, the processor 70 determines which of the microwells 124 include sperm cells based on the recorded data of images in which the sperm cells are identified. For example, the recorded data of images in which a sperm cell is identified can include the time information indicating times at which the images were captured, position information indicating positions of the sperm cell in the flow channel 32 when the images were captured, and the and target cell information indicating that the images contain the sperm cell. Additionally, the processor 70 is informed of the flow rate of the semen sample and a time at which each of the microwells 124 is positioned to receive a respective portion of the semen sample from the outlet 38. Thus, the processor 70 can correlate the recorded data of the images corresponding to the sperm cell to a microwell 124 that was positioned to receive a portion of the semen sample including the sperm cell to determine which microwell 124 includes a sperm cell.

Since a microwell 124 including the sperm cell can be identified by the processor 70, the sperm cell can be recovered from the identified microwell 124. Further, since the sperm cell is identified and recovered without the sperm cell being damaged, the recovered sperm cell can be used for a subsequent procedure. For example, the recovered sperm cell can be used for an IVF treatment.

The system described above in connection with FIGS. 1-3 was tested using a microTESE (microscopic testicular sperm extraction) sample. MicroTESE is a surgical procedure used to retrieve sperm from the seminiferous tubules of a male's testes. Extensive search for sperm cells in the sample by lab experts using conventional approaches failed. In contrast, the system of FIGS. 1-3 detected 55 sperm cells, even though the sample contained significantly more background cells (RBCs and other blood cells) and debris than ordinary semen samples.

The system described above in connection with FIGS. 1-3 was also tested using a post-vasectomy semen sample, where no sperms were found using conventional approaches. In contrast, the system of FIGS. 1-3 detected 22 sperm cells.

Many factors can influence the overall functioning of the system, and the inventors have come up with the following equation that takes into account these parameters. Other versions of the system, for example, with different height of microfluidics channel, flow rate, or frames per second capture rate etc. will follow this equation (1):

$$NTF = \frac{VROI \times FPS \times 3.6}{FR} where , VROI = \frac{L \times W \times H}{{10}^{6}}$$

ROI—Region of interest. Region in the channel that is captured by the camera
NTF—Number of times the target cell is captured in ROI
VROI—Volume in region of interest (in nanoliters)
FPS—Frames per second capture by camera
FR—Flow rate (microliters per hour)
L—Length of ROI (in micrometers)
W—Width of ROI (in micrometers)
H—Height of ROI (in micrometers)

The embodiments described above in connection with FIGS. 1-3 sequentially aliquots the sample into respective ones of a relatively large number of microwells (e.g., >100). And based on the time stamp of sperm image capture, its destination microwell can be determined. In the multi-microwell embodiment, an ODS of ˜90 images per second and a camera FPS 500 (ODS<FPS) may be used.

In alternative embodiments, a two-microwell system may be used in which most of the fluid from outlet will flow into microwell ‘A’ (discard). But every time a target cell is detected, the output is switched to microwell ‘B’ (concentrator). Note, however, that this two-microwell embodiment requires a significantly faster object detection speed (ODS) that is faster than FPS (frames per second) i.e., ODS>FPS. Using equation (1) set forth above, we can bring the FPS down to 100 by playing with Flow rate and NTF. With a sufficiently powerful workstation, the ODS can be increased to 200 thereby achieving ODS>FPS, thereby making this two-microwell system feasible.

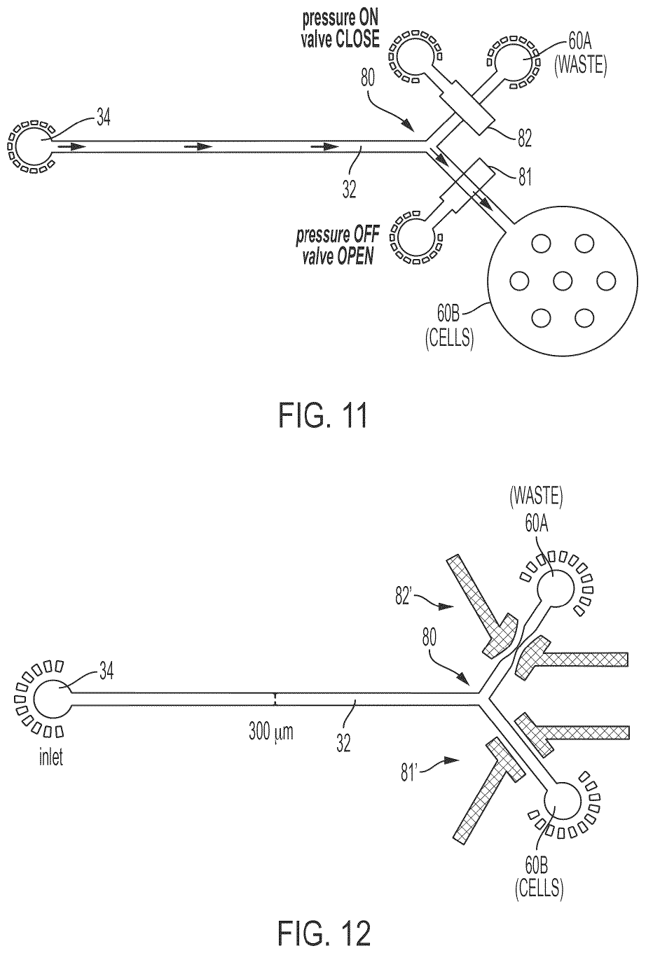

FIG. 10 illustrates an embodiment of another system 11 for identifying and recovering target cells present in a sample. The system 11 is similar to the system 10 described above in connection with FIG. 1, with similarly-numbered components operating as described above in connection with FIGS. 1-9. Except that instead of capturing respective portions of the sample in respective microwells and keeping track of which microwells contain target cells (as described above in connection with FIGS. 1-9), the microfluidics device 300 of the system 11 routes portions of the sample that were determined to include a target biological cell into a single first container 60B, and routes portions of the sample that were not determined to include a target biological cell into a single second destination (i.e., a single second container 60A).

This can be accomplished by using a microfluidic device 300 to implement at least one valve that is configured to route a plurality of first portions of the sample that exit the outlet into the single first container 60B and to route a plurality of second portions of the sample that exit the outlet to the single second container 60A.

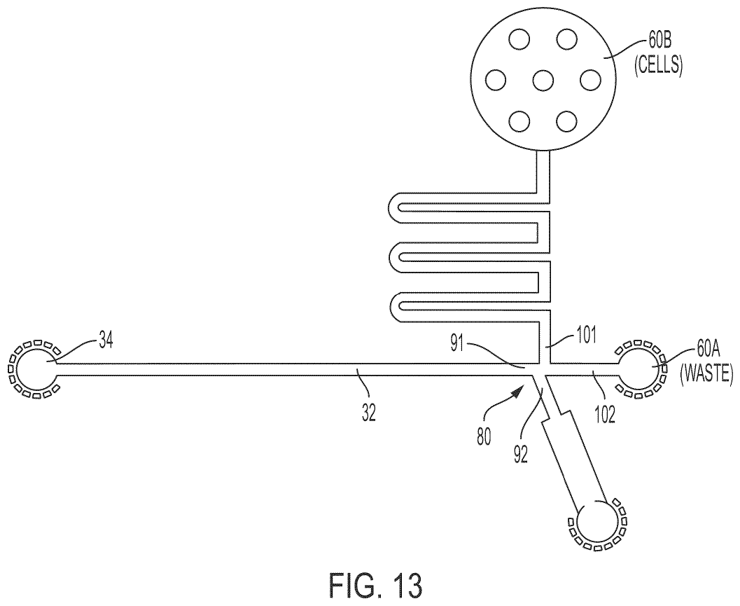

FIG. 11 depicts one approach for using the microfluidic device 300 to implement the at least one valve in the FIG. 10 embodiment. This approach uses two PDMS (polydimethylsiloxane) quake valves 81 and 82, and the sample flows through the flow channel 32 from left to right in FIG. 11. When the processor 70 determines that a portion of the sample that includes a target biological cell is approaching the branching point 80, the processor 70 issues commands that cause the first valve 81 to open and the second valve 82 to close. This will route the portion of the sample that includes the target biological cell to the first container 60B. On the other hand, when the processor 70 has not determined that the portion of the sample that is approaching the branching point 80 includes a target biological cell, the processor 70 issues commands that cause the first valve 81 to close and the second valve 82 to open. This will route this portion of the sample to the second container 60A.

FIG. 12 depicts another approach for using the microfluidic device 300 to implement the at least one valve in the FIG. 10 embodiment. This approach uses two single-layer PDMS sidewall valves 81′ and 82′, and the sample flows through the flow channel 32 from left to right in FIG. 12. When the processor 70 determines that a portion of the sample that includes a target biological cell is approaching the branching point 80, the processor 70 issues commands that cause the first valve 81′ to open and the second valve 82′ to close. This will route the portion of the sample that includes the target biological cell to the first container 60B. On the other hand, when the processor 70 has not determined that the portion of the sample that is approaching the branching point 80 includes a target biological cell, the processor 70 issues commands that cause the first valve 81′ to close and the second valve 82′ to open. This will route this portion of the sample to the second container 60A.

FIG. 13 depicts yet another approach for using the microfluidic device 300 to implement the at least one valve in the FIG. 10 embodiment. This approach uses a fluid-flow circuit having a main flow inlet 91, a first outlet 101, a second outlet 102, and a control flow inlet 92 arranged as depicted in FIG. 13. The fluid-flow circuit is configured so that (a) applying a control flow to the control flow inlet 92 at a first flow rate causes fluid from the main flow inlet 91 to flow out of the first outlet 101 and (b) applying a control flow to the control flow inlet 92 at a second flow rate causes fluid from the main flow inlet 91 to flow out of the second outlet 102. The sample flows through the flow channel 32 from left to right in FIG. 13.

Computational fluid dynamics (CFD) simulations show that when the sample flows through the flow channel 32 at a rate of 600 μl per hour and the control flow that is applied to the control flow inlet 92 is 10 μl per hour (which is much smaller than the flow rate at the main flow inlet 91), the sample will flow through the flow channel 32 and into the main flow inlet 91, and will then continue to the right and exit via the second outlet 102. On the other hand, when the control flow that is applied to the control flow inlet 92 is 4 ml per hour (which is much larger than the flow rate at the main flow inlet 91), the control flow will exit via the second outlet 102, which will cause the sample arriving via the main flow inlet 91 to be diverted into the first outlet 101. In view of this configuration, when the processor 70 determines that a portion of the sample that includes a target biological cell is approaching the branching point 80, the processor 70 issues commands that cause the control flow to operate at 4 ml per hour. This will route the portion of the sample that includes the target biological cell out of the first outlet 101 and into the first container 60B. On the other hand, when the processor 70 has not determined that the portion of the sample that is approaching the branching point 80 includes a target biological cell, the processor 70 issues commands that cause the control flow to operate at 10 μl per hour. This will route this portion of the sample (which does not include a target biological cell) out of the second outlet 102 and into the second container 60A.

According to embodiments disclosed herein, a system and method are provided to identify and recover sperm cells from a semen sample. The disclosed system and method accurately and efficiently identify and recover rare sperm cells in a semen sample having an extremely low sperm count. Moreover, the disclosed system and method do not need to employ potentially harmful markers such as stains, lasers, antibodies, or other markers to identify the sperm cells, and do not require the application mechanical or electrical force to capture the sperm cells. Therefore, the sperm cells can be recovered without being damaged, and thus can be used in subsequent procedures after recovery.

Another application for the embodiments described above in connection with FIGS. 1-13 is to process semen samples for use in In vitro fertilization (IVF), Intrauterine Insemination (IUI), and/or freezing (Cryo) in samples where the sperm count is normal or only a little low (as opposed to extremely low). Currently, semen samples for use in IVF, IUI or Cryo are typically processed using time consuming and labor intensive steps that can often be damaging to sperm. This includes e.g., multiple rounds of centrifugation, sometime in a toxic gradient solution. In contrast, a small aliquot of the semen sample can be diluted in a gentle buffer and then run through the embodiments described above in connection with FIGS. 1-13. The system will then select out the sperm and concentrate them for future use in a much more gentle manner.

The foregoing description describes systems and methods in a context in which a semen sample is the sample to be processed and sperm cells are the target cells to be identified and recovered. However, identifying and recovering other types of rare biological cells in other contexts present similar concerns. Therefore, the methods and system disclosed herein are not limited to identifying and recovering sperm cells. To the contrary-the disclosed systems and methods can identify and recover other types of target cells from other types of samples. For example, the disclosed systems and methods can identify and recover rare biological cells such as, but not limited to, cancer cells, fetal cells, or placenta cells present in a blood sample, a placental fluid sample, or another fluid sample. Additionally, the disclosed systems and methods can be used to perform a complete blood count (CBC), which is routinely used to detect leukemia, anemia, infections, and other disorders.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A method of identifying and recovering biological cells from a sample, the method comprising:
pumping the sample through a flow channel, wherein the sample flows through the flow channel with a non-turbulent flow;
sequentially capturing a plurality of images of the sample as the sample passes through the flow channel;
analyzing the f captured images to determine which portions of the sample include a target biological cell, wherein a determination that a given portion of the sample includes a target biological cell is based on identifying a given target biological cell at respective different locations in a plurality of the captured images;
routing portions of the sample that were determined to include a target biological cell into at least one first container; and
routing portions of the sample that were not determined to include a target biological cell to at least one second destination.

2-3. (canceled)

4. The method of claim 1, wherein the capturing of the plurality of images includes capturing the plurality of images using a camera focused on a vertically central portion of the flow channel having a height between 2 and 8 μm.

5-6. (canceled)

7. The method of claim 1, wherein the analyzing of the plurality of images is implemented using a YOLO object detection model.

8. (canceled)

9. The method of claim 1, wherein the capturing of the plurality of images includes capturing the plurality of images at a rate of at least 100 frames per second.

10. The method of claim 1, wherein portions of the sample that were determined to include a target biological cell are deposited into a single first container, and portions of the sample that were not determined to include a target biological cell are deposited into a single second container.

11-20. (canceled)

21. An apparatus for identifying and recovering biological cells from a sample, the apparatus comprising:
a fluid-flow conduit having an inlet and an outlet, with a flow channel disposed between the inlet and the outlet, wherein the inlet and the flow channel are configured so that the sample flows through the flow channel with a non-turbulent flow;
a pump configured to pump the sample into the inlet so that the sample flows through the flow channel with a non-turbulent flow and exits the outlet, and so that respective portions of the sample are dispensed from the outlet at respective times;
a camera positioned and configured to sequentially capture a plurality of images of the sample as the sample passes through the flow channel;
a stage configured to move a plate that includes a plurality of microwells to respective positions at which respective portions of the sample flow out of the outlet and into respective ones of the plurality of microwells; and
a processor configured to:
analyze the captured images to determine which portions of the sample include a target biological cell, wherein a determination that a given portion of the sample includes a target biological cell is based on identifying a given target biological cell at respective different locations in a plurality of the captured images, and
keep track of which microwells have been filled with a target biological cell.

22-25. (canceled)

26. The apparatus of claim 21, wherein a width of the inlet is greater than a width of the flow channel, and the inlet includes a conical transition to the flow channel.

27. The apparatus of claim 21, wherein the processor keeps track of which microwells have been filled with the target biological cell by recording data corresponding to the plurality of images.

28. The apparatus of claim 21, wherein the camera is positioned and focused to capture images of a vertically central portion of the flow channel having a height between 2 and 8 μm.

29-30. (canceled)

31. The apparatus of claim 21, wherein the processor is further configured to analyze the plurality of images using a YOLO object detection model.

32. (canceled)

33. The apparatus of claim 21, wherein the camera is further configured to capture the plurality of images at a rate of at least 100 frames per second.

34. The apparatus of claim 21, further comprising a controller configured to issue commands to the stage to cause the stage to move the plate to the respective positions.

35-45. (canceled)

46. An apparatus for identifying and recovering biological cells from a sample, the apparatus comprising:
a fluid-flow conduit having an inlet and an outlet, with a flow channel disposed between the inlet and the outlet, wherein the inlet and the flow channel are configured so that the sample flows through the flow channel with a non-turbulent flow;
a pump configured to pump the sample into the inlet so that the sample flows through the flow channel with a non-turbulent flow and exits the outlet, and so that respective portions of the sample exit the outlet at respective times;
a camera positioned and configured to sequentially capture a plurality of images of the sample as the sample passes through the flow channel;
at least one valve configured to route a plurality of first portions of the sample that exit the outlet into at least one first container and to route a plurality of second portions of the sample that exit the outlet to at least one second destination; and
a processor configured to:
analyze the captured images to determine which portions of the sample include a target biological cell, wherein a determination that a given portion of the sample includes a target biological cell is based on identifying a given target biological cell at respective different locations in a plurality of the captured images, and
based on the analyzing, control the at least one valve so that (a) portions of the sample that exit the outlet and were determined to include a target biological cell are routed into the at least one first container and (b) portions of the sample that exit the outlet and were not determined to include a target biological cell are routed to the at least one second destination.

47-50. (canceled)

51. The apparatus of claim 46, wherein a width of the inlet is greater than a width of the flow channel, and the inlet includes a conical transition to the flow channel.

52. The apparatus of claim 46, wherein the camera is positioned and focused to capture images of a vertically central portion of the flow channel having a height between 2 and 8 μm.

53-54. (canceled)

55. The apparatus of claim 46, wherein the processor is further configured to analyze the plurality of images using a YOLO object detection model.

56. (canceled)

57. The apparatus of claim 46, wherein the camera is further configured to capture the plurality of images at a rate of at least 100 frames per second.

58-59. (canceled)

60. The apparatus of claim 46, wherein the at least one valve comprises a plurality of PDMS quake valves.

61. The apparatus of claim 46, wherein the at least one valve comprises a plurality of lateral deflection valves, wherein each of the lateral deflection valves is implemented using a single PDMS layer.

62. The apparatus of claim 46, wherein the at least one valve comprises a fluid-flow circuit having a main flow inlet, a first outlet, a second outlet, and a control flow inlet,
wherein the fluid-flow circuit is configured so that (a) applying a control flow to the control flow inlet at a first flow rate causes fluid from the main flow inlet to flow out of the first outlet and (b) applying a control flow to the control flow inlet at a second flow rate causes fluid from the main flow inlet to flow out of the second outlet,
wherein the first flow rate is larger than a flow rate at the main flow inlet, and
wherein the second flow rate is smaller than the flow rate at the main flow inlet.

63. (canceled)
